(19) United States
(12) Patent Application Publication
(10) Pub. No.: US 2010/0180881 A1
(43) Pub. Date: Jul. 22, 2010

(54) Portable Stove

(76) Inventor: Jan-Nan Chen, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/650,614

(22) Filed: Dec. 31, 2009

(30) Foreign Application Priority Data
Jan. 17, 2009 (TW) 98101838

(51) Int. Cl. A47J 37/07; F24C 15/10; F24C 3/10; F24C 15/08

(52) U.S. Cl. 126/25 R; 126/220; 126/39 E; 126/304 A

(57) ABSTRACT

A portable stove including a body and a cover pivotally connected thereto. The portable stove further includes legs connected thereto through attaching devices so as to enable the stove to stand on a supporting surface. Additionally, the legs are moveable to a position to limit the cover from being pivoted relative to the body when the stove is not in use.

### BACKGROUND OF THE INVENTION

1. Field of the Invention

The present invention relates to a portable stove including a body and a cover pivotally connected thereto and, in particular, to a portable stove including legs connected thereto through attaching devices so as to enable the stove to stand on a supporting surface. Additionally, the legs are moveable to a position to limit the cover from being pivoted relative to the body when the stove is not in use.

2. Description of the Related Art

A portable stove which includes a body, a cover pivotally connected body and a handle to be grasped during transportation thereof, is known. Generally, the stove would include a lock member with which the handle is cooperated to close the stove and prevent it from being opened accidentally. However, it is often encountered that the lock member breaks after the stove is collided with something accidentally. As a result, it would be unsafe to carry the stove because the cover can not be prevented from pivoting relative to the body. Even if the stove is in a storage position that the stove is not open, it is likely that the cover can be accidentally pivoted away from the body.

The present invention is, therefore, intended to obviate or at least alleviate the problems encountered in the prior art.

### SUMMARY OF THE INVENTION

According to the present invention, a portable stove includes a stove body including a body including a top opening and a cover pivotally connected to the body and being pivotal in position to open and close the top opening. The portable stove further includes at least two attaching devices disposed on an exterior side of the body, and in which one of the at least two attaching devices is connected to a proximal end thereof and the other is connected to a distal end thereof respectively. Furthermore, each of the at least two attaching devices includes at least one lug and a cap extending therefrom, and in which one of the at least two attaching devices includes its cap extending over a proximal end of the cover, and the other includes its cap extending over a distal end of the cover. Moreover, at least two legs are pivotally connected to the at least two attaching devices respectively, and in which each of the at least two legs is pivotally connected to the at least one lug of the associated one of the at least two attaching devices. Additionally, each of the at least two legs is pivotal about a pivot away from and toward the body.

Other objects, advantages, and new features of the present invention will become apparent from the following detailed description of the invention when considered in conjunction with the accompanied drawings

### BRIEF DESCRIPTION OF THE DRAWINGS

FIG. 1 is a perspective view of a portable stove in accordance with a first embodiment of the present invention.

FIG. 2 is an exploded perspective view of the portable stove of FIG. 1.

FIG. 3 is a partial, enlarged view of FIG. 2.

FIG. 4 is another partial, enlarged view of FIG. 2.

FIG. 5 is a side view of the portable stove of FIG. 1.

FIG. 6 is a partial, enlarged view of FIG. 5.

FIG. 7 is another partial, enlarged view of FIG. 5.

FIG. 8 is a cross-sectional view taken along line 8-8 in FIG. 1.

FIG. 9 is an extended cross sectional view of FIG. 8, showing the portable stove in another position.

FIG. 10 is a side view illustrating the pivoting of a leg thereof.

FIG. 11 is an extended side view of FIG. 10, showing each leg in another position different from a position shown in FIG. 1.

FIG. 12 is a cross-sectional view taken along line 12-12 in FIG. 11.

FIG. 13 is an extended cross-sectional view of FIG. 12, showing the legs limiting the pivoting of a cover thereof.

FIG. 14 is a cross-sectional show showing a portable stove in accordance with a second embodiment of the present invention.

FIG. 15 is a perspective view of a portable stove in accordance with a third embodiment of the present invention.

### DETAILED DESCRIPTION OF THE PREFERRED EMBODIMENT

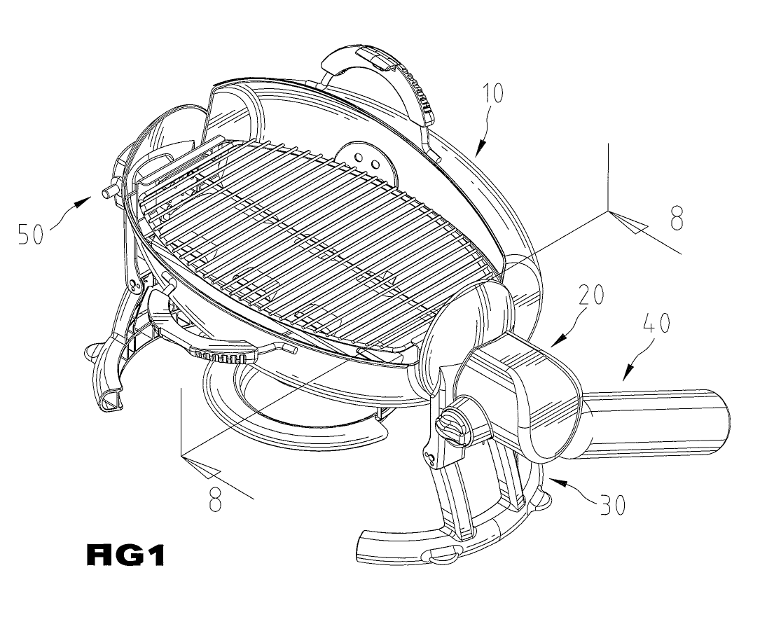

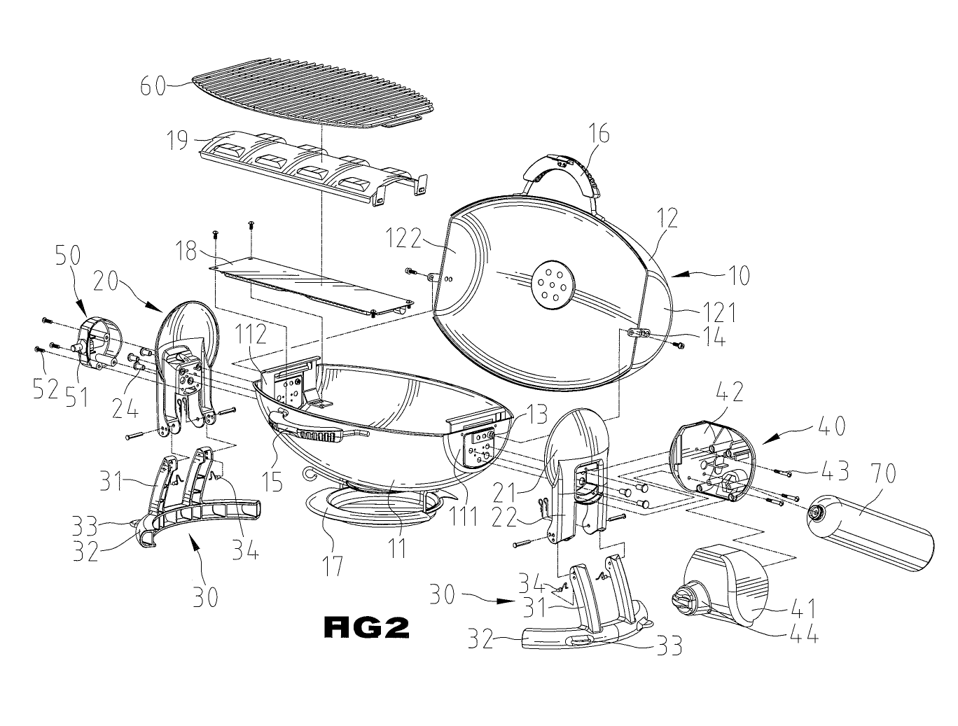

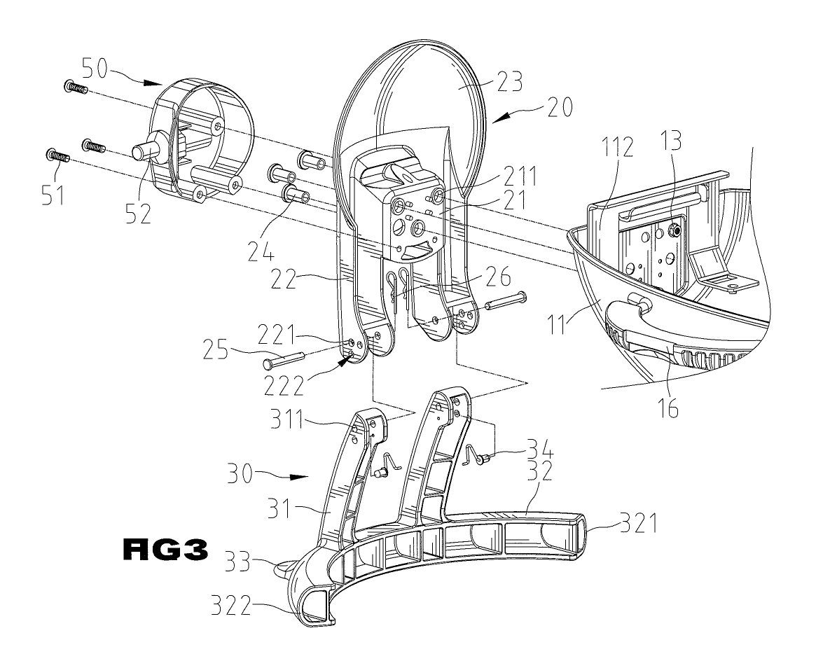

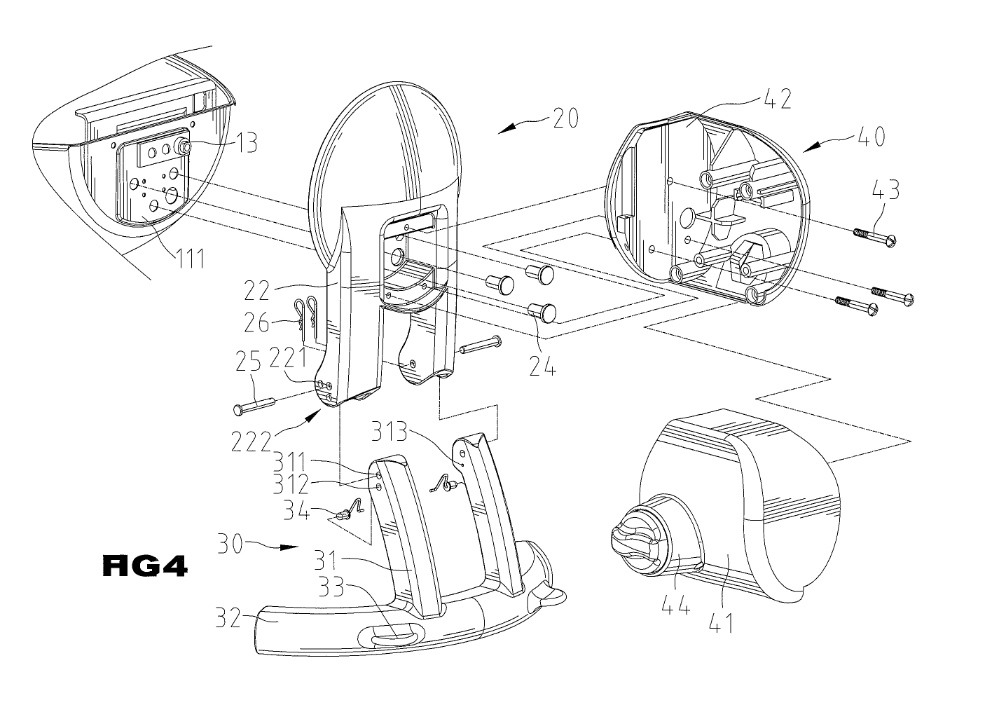

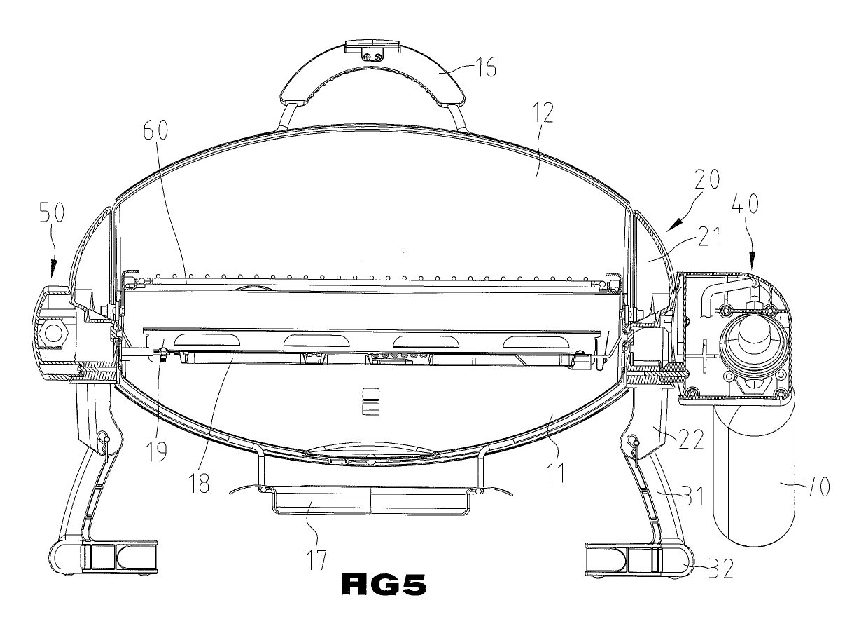

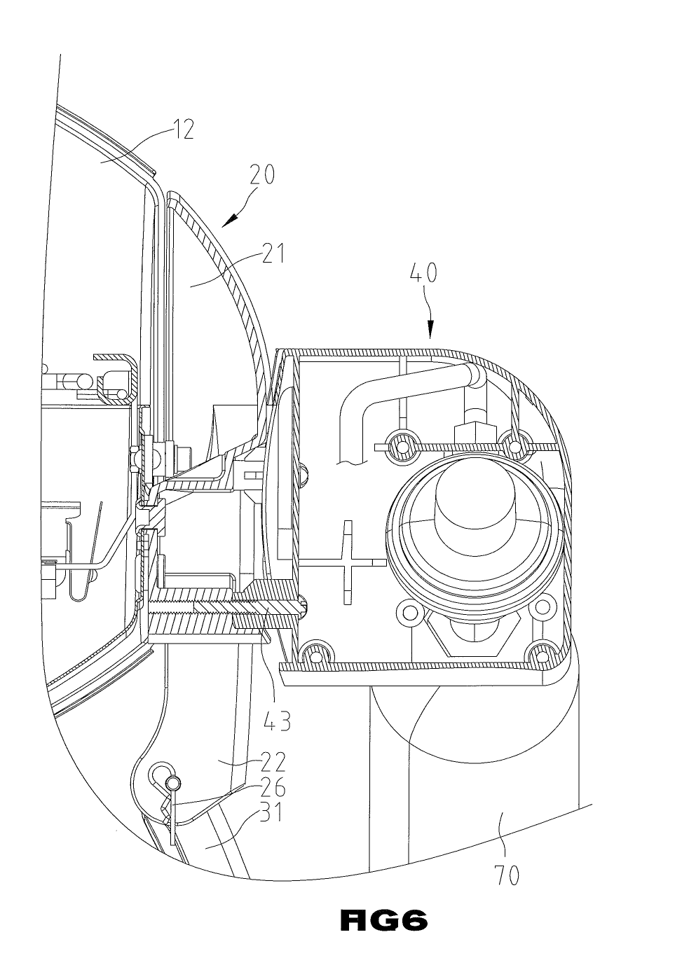

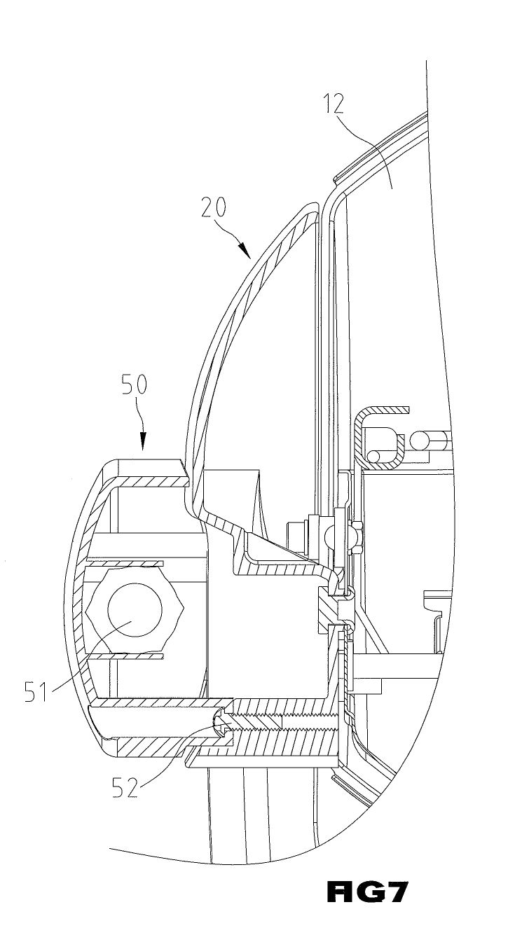

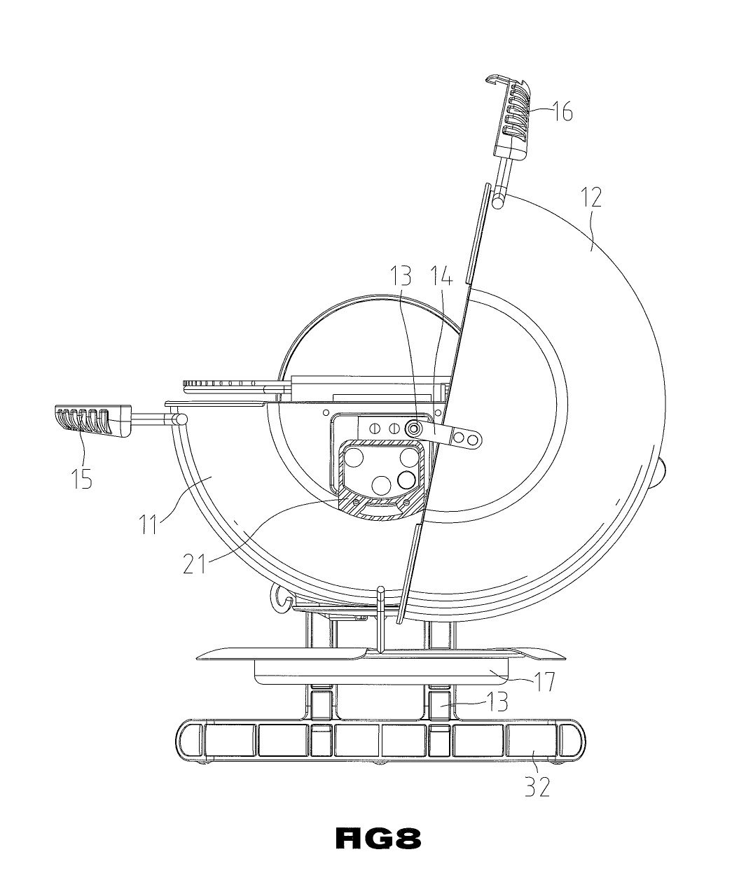

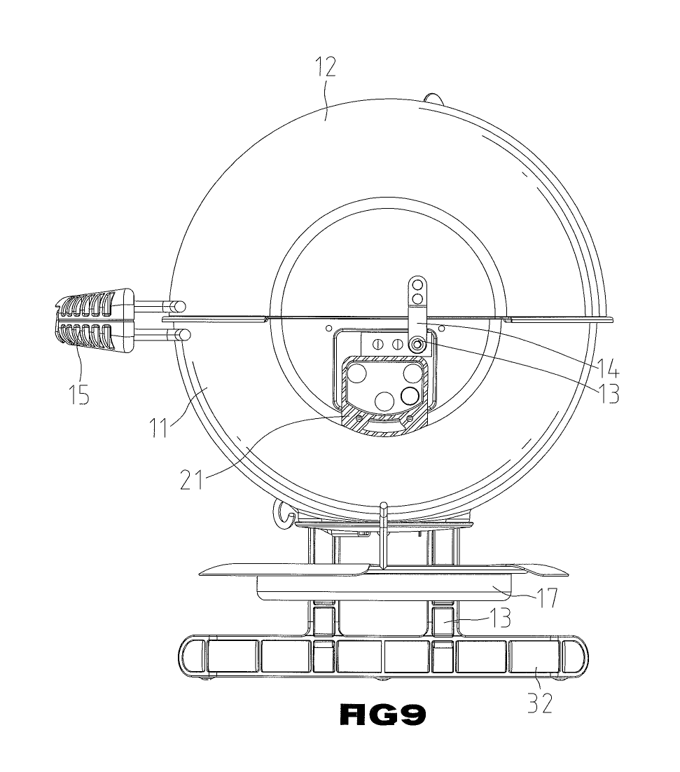

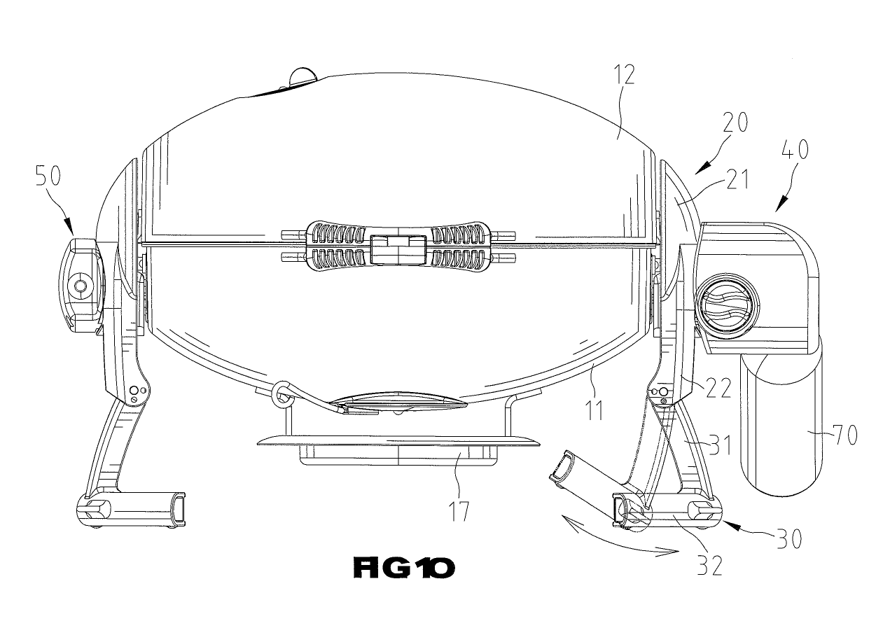

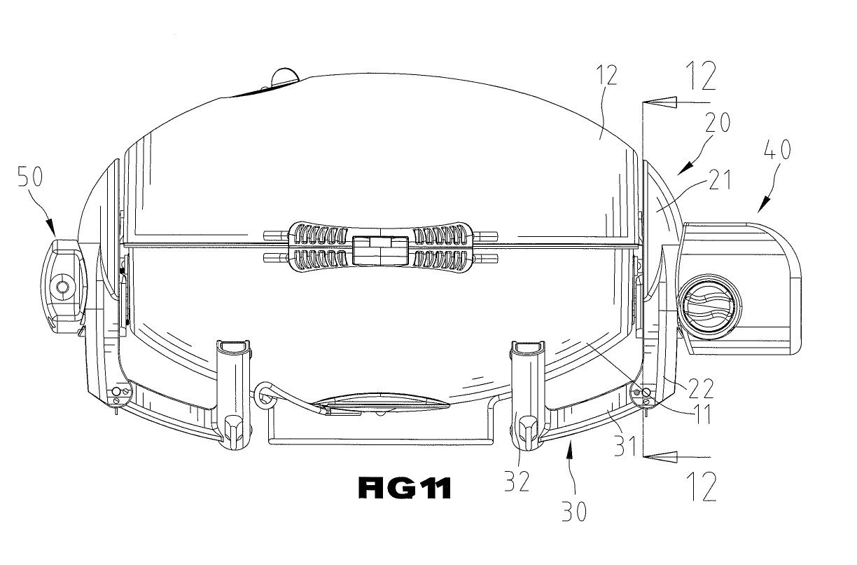

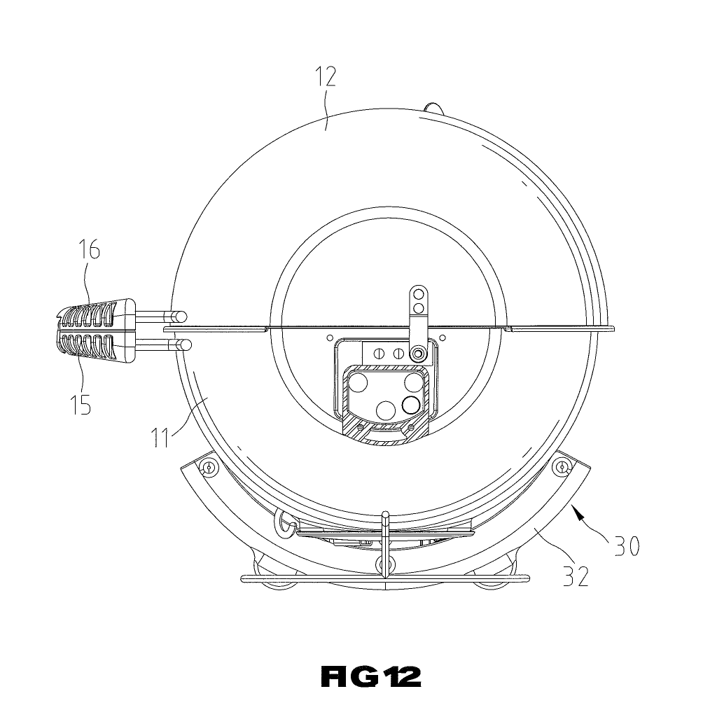

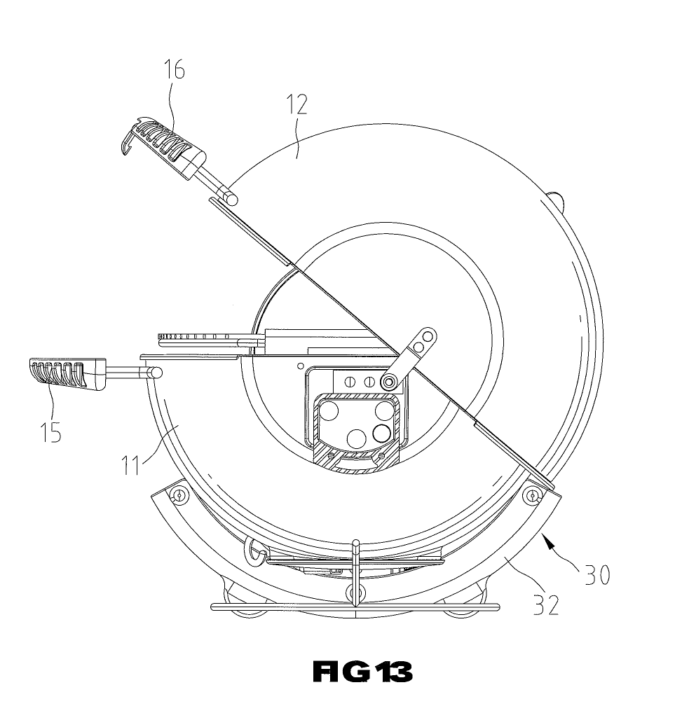

FIGS. 1 through 13 show a portable stove in accordance with a first embodiment of the present invention. The portable stove includes a stove body 10 including a body 11 in which a heating apparatus 18, an air vent 19, and a grate 60 are disposed, and which are preferably inserted in the body 10 through a top opening formed thereon. The body 11 is of a substantially semi-oval shape and includes a proximal end 111 forming a flat surface and a distal end 112 forming a flat surface, respectively. The stove body 10 also includes a cover 12 pivotally connected to the body 11. The cover 12 is of a substantially semi-oval shape and includes a proximal end 121 forming a flat surface and a distal end 122 forming a flat surface, respectively. The cover 12 is pivotal in position to open and close the top opening. Upon the cover 12 closing the top opening of the body 11, the body 11 has a first edge and the cover 12 has a second edge, which has the same contour as the first edge, contacting with the first edge. Additionally, the body 11 includes two first pivotal joints 13 mounted thereon, and one of which is disposed on the proximal end 111 thereof while the other is disposed on the distal end 112 thereof, respectively. Furthermore, the cover 12 includes two second pivotal joints 14 mounted thereon, and one of which is disposed on the proximal end 121 thereof while the other is disposed on the distal end 122 thereof, respectively. The cover 12 is pivotally connected to the body 10 by connecting one first pivotal joint 13 to one second pivotal joint 14 respectively.

In addition, the body 11 includes an exterior side including a first ergonomic handle 15 connected thereto; and the cover 12 includes an exterior side including a second ergonomic handle 16 connected thereto and latched with the first handle 15 when the top opening of the body 11 is fully closed by the cover. Each of the first 15 and second 16 handles includes proximal and distal ends attached to the associated body 11 and cover 12. Also, each of the first 15 and second 16 handles includes a middle portion spaced from the exterior side of the associated body 11 and cover 12 such that a person's hand or a carrying device can extend through these spaces for the transportation of the portable stove.

Furthermore, the body 11 includes a bottom opening such that oil and grease can flow thereout and collected by a drip pan 17. The drip pan 17 is supported by a frame fixed to the exterior side of the body 11 and is in a position corresponding to the bottom opening.

The portable stove further includes two attaching devices 20 connected to the body 11. Each attaching device 20 includes a connecting section 21 for connecting it to the body 10. Additionally, one attaching device 20 is disposed on the exterior side of the body 11 at the proximal end 111 thereof while the other is disposed on the exterior side of the body 11 at the distal end 112 thereof. In the embodiment, each attaching device 20 includes a plurality of fasteners 24 inserting into a plurality of through holes 211 formed in its connecting section 21 and engaging with the body 11 to secure the attaching device 20 to the body 11.

In addition, each attaching device 20 includes at least one lug 22 extending from its connecting section 21, and which connects to a leg 30. In the embodiment, each attaching device 20 includes two lugs 22. Furthermore, each attaching device 20 includes a cap 23 extending from its connecting section 21. Moreover, the attaching device 20 that is disposed at the proximal end 111 of the body 11 includes its cap 23 extending over the proximal end 121 of the cover 12 and also enclosing the first pivotal joint 13 at the proximal end 111 of the body 11. Likewise, the attaching device 20 that is disposed at the distal end 112 of the body 11 includes its cap 23 extending over the distal end 122 of the cover 12 and also enclosing the first pivotal joint 13 at the distal end 112 of the body 11. In addition, the cap 23 that extends over the proximal end 121 of the cover 12 has a substantially dome shape with a curved circumferential edge conforming to a curved circumferential edge of the proximal end 121 so as to make the look of the portable stove move streamlined and aesthetically pleasing. Likewise, the cap 23 that extends over the distal end 122 of the cover 12 has a substantially dome shape with a curved circumferential edge conforming to a curved circumferential edge of the distal end 122 for the same purpose.

The legs 30 are pivotally connected to the respective attaching devices 20, and each of which includes a corresponding number of first leg structures 31 to the lugs 22 and connecting to the lugs 22 respectively, thereby connecting it to the associated attaching device 20. In the embodiment, upon the legs 30 being pivotally connected to the associated attaching devices 20, each attaching device 20 includes a pivot 25 inserting through an aperture 221 formed in each lug 22 as well as an aperture 311 formed in the associated first leg structure 31 to pivotally connect the legs 30 to the associated attaching devices 20. In addition, each pivot 25 is prevented from disengagement from the apertures 221 and 311 in that it includes a head with a diametrical size such that the head can not pass through the apertures 221 and 311, and a retainer 26 engaged with the pivot 25 such that the retainer 26 prevents the pivot 25 from being pulled out of the apertures 221 and 311 after being inserted therethrough. Each leg 30 further includes a second leg structure 32 connecting its first leg structure(s) 31 and extending in a direction different to a longitudinal direction of the first leg structure(s) 31. In the embodiment, the second leg structure 32 of each leg 30 connects two first leg structures 31.

In addition, each leg 30 is pivotal about the associated pivot 25 away from and toward the body 11. Furthermore, upon the legs 30 being pivoted away from the body 11, each leg 30 includes its second leg structure 32 adapted to stand on a supporting surface to support the portable stove above the supporting surface stably. Each second leg structure 32 includes a surface having a cross sectional area substantially large enough to stably support the portable stove. This specific surface is of a cross-sectional size greater than a connecting surface of any associated first leg structure 31 that connects the first leg structure 31 to second leg structure 32 so as to stably support the portable stove. Additionally, the cover 12 can be pivoted relative to the body 11 through a first range until it is limited by the attaching devices 20. Moreover, upon the legs 30 being pivoted toward the body 11, each leg 30 includes its second leg structure 32 in position to limit the cover 12 from being pivoted relative to the body 11, thus resolving the problem set forth in the prior art. In this case, the cover 12 can only be pivoted relative to the body 11 through a second range which is much smaller than the first range. Furthermore, each second leg structure 32 includes a proximal end 321 and a distal end 322 and extends in a curved line from the proximal 321 to distal 322 ends. Moreover, each second leg structure 32 includes at least one protuberance 33 extending outward from a curved peripheral edge thereof and in a direction different to a longitudinal direction of the associated second leg structure 32. In the embodiment, each second leg structure 32 includes two protuberances 33, and each of which is disposed away from the middle between the proximal 321 and distal 322 ends thereof. The protuberances 33 are adapted to stand on a supporting surface to support the portable stove above the supporting surface stably upon the legs 30 being pivoted toward the body 11.

Furthermore, the legs 30 are locked in a fixed position after they are pivoted away from the body 11, and with the associated second leg structures 32 standing on a supporting surface. Moreover, the legs 30 are locked in a fixed position after they are pivoted toward the body 11, and with the associated protuberances 33 standing on a supporting surface. In the embodiment, upon the legs 30 being locked and prevented from being with respect to the associated attaching devices 20, each leg 30 includes a corresponding number of locking members 34 to first leg structures 31 and connecting to the first leg structures 31 respectively. Each first leg structure 31 includes an engaging head and an elastic tail member extending therefrom, and the head end is inserted through a hole 312 formed in the associated first leg structure 31 and selectively engages in one of two positioning holes 222 formed in the associated lug 22 while the tail end member is engaged in a hole 313 formed in the specific first leg structure 31.

The portable stove further includes a fuel can adapter 40 connected to one of the attaching devices 20 to engage with a fuel can 70 and an igniting device 50 connected to the other. The fuel can adapter 40 includes two casing halves including a first casing halve 41 and a second casing halve 42 and which are adapted to be complemently fitted with each other. Additionally, the fuel can adapter 40 includes a plurality of fasteners 43 inserting through the second casing halve 42 and engage in the associated attaching device 20 to secure the fuel can adapter 40 with the specific attaching device 20. Furthermore, the fuel can adapter 40 includes a control knob 44 cooperated with the fuel can 70. As to the igniting device 50, the igniting device 50 includes a plurality of fasteners 51 inserting therethrough and engage in the associated attaching device 20 to secure it with the specific attaching device 20. Furthermore, the igniting device 50 includes an igniting button 52 adapted to be operated to ignite fuel.

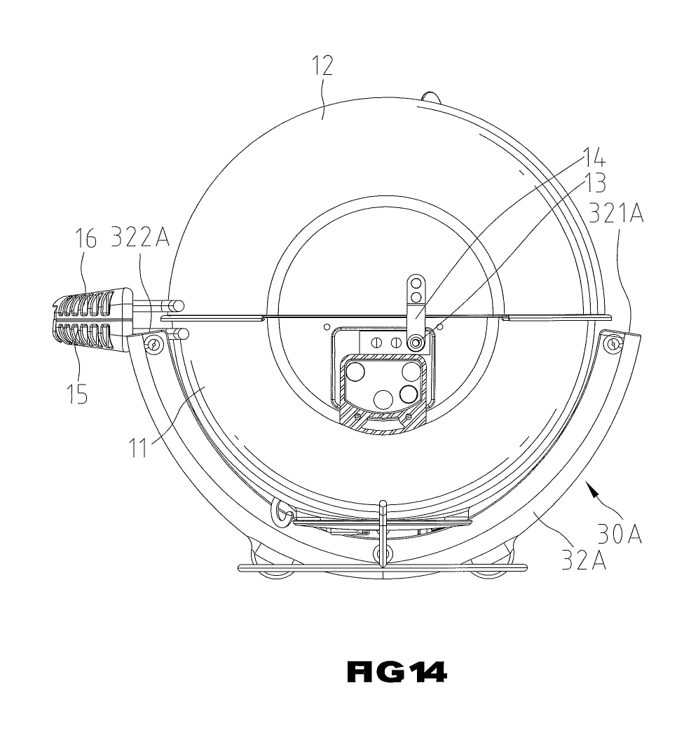

FIG. 14 shows a portable stove in accordance with a second embodiment of the present invention. The second embodiment differentiates from the first embodiment in that it substitutes legs 30 with legs 30A. The difference between each leg 30 and leg 30A is that each leg 30A includes a second leg structure 32A which extends in a length longer than that of the second leg structure 32 of each leg 30 such that the leg structure 32A includes its proximal 321A and distal 321A ends adjacent to an edge of the cover 12. In this case, the cover 12 can only be pivoted relative to the body 11 through a third range which is much smaller than the second range.

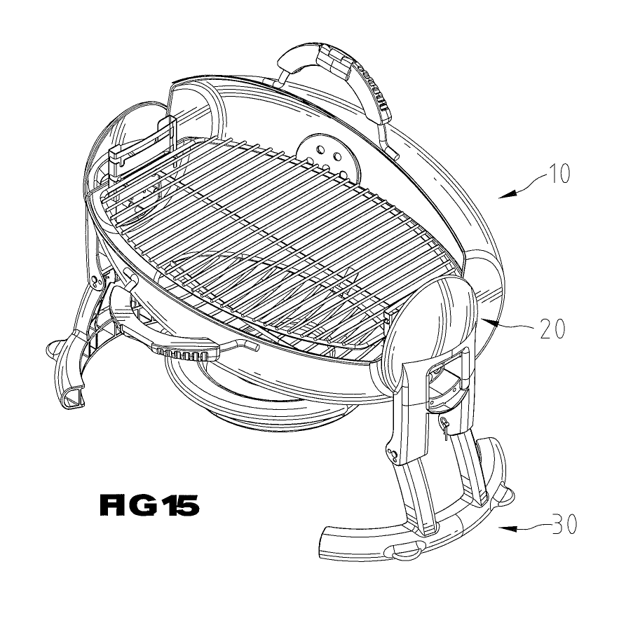

FIG. 15 shows a portable stove in accordance with a third embodiment of the present invention. The third embodiment differentiates from the first embodiment in that it eliminates the fuel can adapter 40 and the igniting device 50. Therefore, the heating apparatus 18 that is in fluidal communication with the fuel can adapter 40 is eliminated. In this case, coals and something that can be burnt to produce heat are disposed in the body 11 when in use of this portable stove.

In view of forgoing, it is intended to avoid each mounting leg 30, which is to perform the aforementioned function, directly on the body 11 so as to avoid the body 11 including too many cutouts and maintain the body 11 with a good structural strength as well as reduce the manufacturing steps thereof. Additionally, since each leg 30 has its first leg structures 31 structurally contacted with the lugs 22 of the associated attaching device 20, the legs 30 are more effectively to support the portable stove stably.

While the specific embodiments have been illustrated and described, numerous modifications come to mind without significantly departing from the spirit of invention and the scope of invention is only limited by the scope of accompanying claims.

What is claimed is:

1. A portable stove, comprising:
a stove body including a body including a top opening and a cover pivotally connected to the body and being pivotal in position to open and close the top opening;
at least two attaching devices connected to and disposed on an exterior side of the body, with one of the at least two attaching devices connected to a proximal end thereof and the other connected to a distal end thereof respectively, with each of the at least two attaching devices including at least one lug and a cap extending therefrom, and with one of the at least two attaching devices includes its cap extending over a proximal end of the cover and the other including its cap extending over a distal end of the cover; and
at least two legs pivotally connected to the at least two attaching devices respectively, with each of the at least two legs pivotally connected to the at least one lug of the associated one of the at least two attaching devices, and with each of the at least two legs being pivotal about a pivot away from and toward the body.

2. The portable stove as claimed in claim 1 wherein the cover is adapted to be limited by the at least two attaching devices when the cover pivots through a first range relative to the body, and with the at least two legs pivoted away from the body.

3. The portable stove as claimed in claim 2 wherein each of the at least two legs includes at least one first leg structure pivotally connected to the at least one lug of the associated one of the at least two attaching devices, and a second leg structure connecting the at least one first leg structure and extending in a direction different to a longitudinal direction of the at least one first leg structure.

4. The portable stove as claimed in claim 3 wherein the cover is adapted to be limited by the second leg structures of the respective at least two legs to limit the cover from being pivoted relative to the body, and with one of the at least two legs pivoted away from the body.

5. The portable stove as claimed in claim 4 wherein the cover is adapted to be pivoted relative to the body through a second range, with one of the at least two legs pivoted away from the body, and with the second range being smaller than the first range.

6. The portable stove as claimed in claim 1 wherein one of the at least two attaching devices includes a fuel can adapter connected thereto to engage with a fuel can.

7. The portable stove as claimed in claim 6 wherein the other of the at least two attaching devices includes an igniting device connected thereto, and with the igniting device adapted to be operated to ignite fuel.

8. The portable stove as claimed in claim 5 wherein the second leg structure of the associated one of the at least two legs extends in a length and includes proximal and distal ends being adjacent to an edge of the cover, with the cover adapted to be pivoted relative to the body through a third range, and with the third ranger being smaller than the second range.

9. The portable stove as claimed in claim 1 wherein each of the at least two legs is locked in a fixed position by a locking member after it is pivoted away from the body, and wherein each of the at least two legs is locked in a fixed position after it is pivoted toward the body by the associated locking member.

10. The portable stove as claimed in claim 3 wherein the second leg structures of the respective at least two legs are adapted to stand on a supporting surface to support the portable stove above the supporting surface stably and in which the at least two legs are pivoted away from the body, and wherein the second leg structure of the associated one of the at least two legs includes at least one protuberance extending outward therefrom and in a direction different to a longitudinal direction of the associated second leg structure, with the at least one protuberance adapted to stand on the supporting surface to support the portable stove above the supporting surface stably, and in which the at least two legs pivoted towards the body.
